(19) United States
(12) Patent Application Publication
(10) Pub. No.: US 2007/0287064 A1
(43) Pub. Date: Dec. 13, 2007

(54) BINDER RESIN EMULSION FOR ENERGY DEVICE ELECTRODE AND ENERGY DEVICE ELECTRODE AND ENERGY DEVICE THAT USE SAME

(76) Inventors: Kenji Suzuki, Hitachi-shi (JP); Kiyotaka Mashita, Ichihara-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/836,954

(22) Filed: Aug. 10, 2007

Related U.S. Application Data
(63) Continuation of application No. PCT/JP2005/022555, filed on Dec. 8, 2005.

(30) Foreign Application Priority Data
Feb. 10, 2005 (JP) 2005-034772

(51) Int. Cl. H01M 4/62

(52) U.S. Cl. 429/217; 252/182.1

(57) ABSTRACT

A binder resin emulsion for energy device electrodes is provided that is used in energy device electrodes and more particularly that is used as a binder to dispose an active material on the current collector of such an electrode. An energy device electrode and energy device that use this emulsion are also provided. A binder resin emulsion for energy device electrodes is used that comprises: a copolymer of an α,β-unsaturated carboxylic acid and an α-olefin that has been neutralized with a neutralizing agent; and water. Also, an energy device electrode and an energy device that use this binder resin emulsion are utilized.

### TECHNICAL FIELD

The present invention relates to a binder resin emulsion for energy device electrodes and to energy device electrodes and energy devices that use this binder resin emulsion for energy device electrodes.

### BACKGROUND ART

Energy devices such as lithium ion secondary batteries (referred to hereafter simply as lithium batteries) and electric double-layer capacitors (referred to hereafter simply as capacitors) are already known as means for storing electricity.

Lithium batteries, while suffering from the drawbacks of a short life and weak overcharge/overdischarge behavior, offer the advantages of no memory effect and a high energy density and as a result have come to be widely used as, for example, power sources for mobile information terminals such as notebook computers, mobile phones, and PDAs.

Capacitors, on the other hand, are energy devices that utilize the capacitance of the electric double layer that can set up at the interface between an electrode active material and an electrolyte. Although their energy density is lower than that of lithium batteries, capacitors offer the advantages of a long life (high reliability) and an excellent rapid charge/discharge behavior (high input/output) and as result are used, for example, as small-scale back-up power sources for the memory in AV equipment, telephone sets, and facsimile machines.

The electrodes used in such energy devices typically comprise a current collector and a composite layer disposed on the current collector. This composite layer is a layer comprising the active material and a binder resin composition and is provided in order to dispose the active material on the surface of the current collector. The active material on the current collector functions to deliver and uptake ions.

A carbon material, for example, may be used as the negative electrode active material in the case of lithium batteries. This carbon material has a multilayer structure and engages in the delivery and uptake of lithium ions based on the insertion of lithium ions between these layers (formation of a lithium intercalation compound) and the discharge of lithium ions from between the layers.

A water-dispersed emulsion of styrene-butadiene copolymer (SBR) particles and a binary liquid-type material comprising SBR and the sodium or ammonium salt of carboxymethyl cellulose (CMC) (as a water-soluble polymeric thickener) have been used (Japanese Patent Application Laid-open No. H 5-74461) as the binder resin composition for bonding the active material to the current collector in the aforementioned lithium batteries.

SBR, however, readily adsorbs to the carbon material used as the negative electrode active material and thus has a tendency to coat the surface of the carbon material. This makes it difficult for the lithium ion-containing electrolyte solution to permeate into the composite layer comprising the aforementioned active material and binder resin composition, and as a result lithium ion delivery and uptake by the carbon material has been impaired. When in particular the aforementioned composite layer is compression formed onto the current collector at high pressures using, for example, a roll press, the voids present in the composite layer are reduced and permeation of the electrolyte solution is made even more difficult, which has resulted in an additional reduction in the charge/discharge characteristics. Prior to the production of the composite layer, the SBR in an active carbon-containing water-dispersed emulsion of the binder resin composition strongly adsorbs to the carbon material that is the active material and the carbon material may then sediment, which has thwarted the effort to have the composite layer obtained from the emulsion be uniform.

The capacitor under consideration, on the other hand, uses a high specific surface area active carbon as its active material. Electricity can be charged and discharged by the physical adsorption/desorption of ions in the electrolyte at this active carbon.

A binary liquid-type material comprising a water-dispersed emulsion of polytetrafluoroethylene (PTFE) particles and the sodium or ammonium salt of carboxymethyl cellulose (CMC) (as a water-soluble polymeric thickener) has been used as the binder resin composition for bonding the aforementioned capacitor active material to the current collector (WO 98/58397). However, just as with lithium batteries, a problem here has been that the binder resin composition coats the active carbon, which impedes ion adsorption/desorption and thereby impedes the formation of the electric double layer. As a result, the obtained capacitor electrode has exhibited high resistance and there has been a problem with long-term reliability

### DISCLOSURE OF THE INVENTION

A first object of the present invention is to provide a binder resin emulsion for energy device electrodes, that is used in energy device electrodes and more particularly that is used as a binder to dispose active material on the current collector of such an electrode.

A second object of the present invention is to provide such a binder resin emulsion for energy device electrodes, wherein the active material exhibits an excellent dispersion stability (resistance to sedimentation) in the emulsion.

A third object of the present invention is to provide a binder resin emulsion for energy device electrodes and an energy device electrode that uses same, whereby, with respect to the composite layer obtained from the aforementioned active material and the aforementioned binder resin emulsion, the binder resin emulsion does not coat the surface of the negative electrode active material of the energy device, particularly with regard to lithium batteries, and an excellent permeation by the electrolyte solution is thereby made possible.

A fourth object of the present invention is to provide a lithium battery electrode that exhibits excellent charge/discharge characteristics at high densities, a lithium battery that uses this electrode, a capacitor electrode that exhibits a reduced resistance and an improved long-term reliability, and a capacitor that uses this capacitor electrode.

As a result of intensive and extensive research, the present inventors discovered that the aforementioned objects could be achieved by the water-dispersed emulsion of a binder resin obtained by neutralizing a carboxyl-functional modified polyolefin.

That is, the present invention relates to

1. a binder resin emulsion for an energy device electrode, comprising: a copolymer of an α,β-unsaturated carboxylic acid and an α-olefin that has been neutralized with a neutralizing agent; and water;

2. the binder resin emulsion for an energy device electrode according to 1. above, wherein the copolymer is an ethylene-(meth)acrylic acid copolymer, and the neutralizing agent is an amine compound;

3. the binder resin emulsion for an energy device electrode according to 2. above, wherein the copolymer has an MFR of 30 to 100 g/10 min, and the ethylene unit/(meth)acrylic acid unit mass ratio is 85/15 to 75/25;

4. the binder resin emulsion for an energy device electrode according to 2. or 3. above, wherein the neutralizing agent is an alkanolamine;

5. the binder resin emulsion for an energy device electrode according to any one of 1. to 4. above, wherein 20 to 100 mol % of the carboxyl groups in the copolymer are neutralized;

6. an energy device electrode having a current collector and a composite layer disposed on at least one side of the current collector, wherein said composite layer is obtained by the steps of:

(a) applying onto the current collector a slurry comprising an active material and the binder resin emulsion for an energy device electrode according to any one of 1. to 5. above; and

(b) removing a solvent from the applied slurry;

7. an energy device comprising the energy device electrode according to 6. above; and

8. the energy device according to 7. above, wherein the energy device is a lithium battery or a capacitor.

The binder resin emulsion for energy device electrodes of the present invention, considered at the level of the water-based slurry containing active material and this binder resin emulsion, resists adsorption to the active material, for example, carbon material, and resists coating the surface of the active material. As a consequence, an energy device electrode fabricated using the binder resin emulsion of the present invention, and particularly the negative electrode for a lithium battery, can provide an excellent electrolyte solution infiltrability into the composite layer obtained by the application and drying of the aforementioned water-based slurry and can provide a higher density for the energy device and improved charge/discharge characteristics. In addition, a capacitor that uses a capacitor electrode fabricated using the binder resin emulsion of the present invention has a low resistance and an excellent long-term reliability. High-performance energy devices are thus obtained through the use of these energy device electrodes.

### BEST MODE FOR CARRYING OUT THE INVENTION

The binder resin emulsion of the present invention is used for energy devices and particularly for the electrodes in energy devices. As noted above, the electrode of an energy device comprises a current collector and a composite layer disposed thereon. This composite layer comprises active material and a binder resin composition obtained from a binder resin emulsion. The binder resin emulsion is used for fabrication of the composite layer, whereby the composite layer is obtained by preparing a slurry by dispersing the active material in the binder resin emulsion, coating this slurry on a current collector, and drying. The binder resin emulsion, energy device electrode, and methods for producing them, inter alia, are described below.

(1) The Binder Resin Emulsion for Energy Device Electrodes

The binder resin emulsion of the present invention for an energy device electrode comprises a solvent such as water, an α-olefin-α,β-unsaturated carboxylic acid copolymer that has been neutralized with a neutralizing agent, and other optional substances.

(1-1) The α-olefin-α,β-unsaturated carboxylic acid copolymer

The α-olefin-α,β-unsaturated carboxylic acid copolymer in the present invention is obtained by the copolymerization of an α,β-unsaturated carboxylic acid with an α-olefin using a suitable catalyst. This polymerization, for example, can employ existing polymerization methods, such as pressurized polymerization.

(1-1-1) The α-olefin

The α-olefin can be exemplified by compounds with the following formula (I).
CH₂═CH—R (I)
R in formula (I) is selected from the hydrogen atom, C₁₋₁₂ and preferably C₁₋₄ alkyl groups which may be branched or unbranched and saturated or unsaturated, C₃₋₁₀ alicyclic alkyl groups which may be saturated or unsaturated, and C₆₋₁₂ aryl groups. The alkyl encompassed by R may optionally be substituted by halogen, alkyl, alkoxyl, and so forth. Ethylene, propylene, and butylene are particularly preferred for the α-olefin used here.
(1-1-2) The α,β-Unsaturated Carboxylic Acid

The α,β-unsaturated carboxylic acid is exemplified by compounds with the following formula (II). 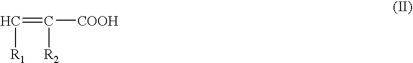
R₁ and R₂ in formula (II) may be the same as each other or may differ from one another and are selected from the hydrogen atom, carboxyl group, acetyl group, C₁₋₁₂ and preferably C₁₋₄ alkyl groups which may be branched or unbranched and saturated or unsaturated, C₃₋₁₀ alicyclic alkyl groups which may be saturated or unsaturated, and C₆₋₁₂ aryl groups. The alkyl encompassed by R₁ and R₂ may optionally be substituted by halogen, alkyl, alkoxyl, carboxyl, and so forth. (Meth)acrylic acid (here and below, this denotes acrylic acid and methacrylic acid), ethacrylic acid, crotonic acid, maleic acid, itaconic acid, citraconic acid, fumaric acid, and so forth are particularly preferred for the α,β-unsaturated carboxylic acid used here.
(1-1-3) The Copolymer

With regard to the mass ratio between the α-olefin and α,β-unsaturated carboxylic acid, an α-olefin unit/α,β-unsaturated carboxylic acid unit mass ratio of, for example, 96/4 to 50/50, preferably 90/10 to 65/35, and more preferably 85/15 to 75/25 is suitable.

Viewed from the perspective of electrode pliability flexibility, a preferred α-olefin and α,β-unsaturated carboxylic acid combination is the combination of ethylene for the α-olefin and (meth)acrylic acid for the α,β-unsaturated carboxylic acid. This combination yields an ethylene-(meth)acrylic acid copolymer. The anhydride of the α,β-unsaturated carboxylic acid may be used during polymerization as the α,β-unsaturated carboxylic acid rather than a compound with formula (II). In addition, the α-olefin may be a single α-olefin or a combination of two or more α-olefins, and the α,β-unsaturated carboxylic acid may be a single α,β-unsaturated carboxylic acid or a combination of two or more unsaturated carboxylic acids.

(1-1-4) The Properties of the Copolymer

The obtained α-olefin-α,β-unsaturated carboxylic acid copolymer is not particularly limited; however, taking into consideration the balance between the electrode pliability flexibility and the ability to form a water-dispersed emulsion with the neutralizing agent, an MFR (melt flow rate, JIS K-6760, this applies hereafter) of 3 to 500 g/10 min, preferably 10 to 300 g/10 min, and more preferably 30 to 100 g/10 min is suitable.

In particular, a preferred α-olefin-α,β-unsaturated carboxylic acid copolymer is suitably an ethylene-(meth)acrylic acid copolymer having a molecular weight corresponding to an MFR of 3 to 500 g/10 min and an ethylene unit/(meth)acrylic acid unit mass ratio of 96/4 to 50/50, more preferably having a molecular weight corresponding to an MFR of 10 to 300 g/10 min and an ethylene unit/(meth)acrylic acid unit mass ratio of 90/10 to 65/35, and even more preferably having a molecular weight corresponding to an MFR of 30 to 100 g/10 min and an ethylene unit/(meth)acrylic acid unit mass ratio of 85/15 to 75/25.

A single such α-olefin-α,β-unsaturated carboxylic acid copolymer may be used or two or more of these α-olefin-α,β-unsaturated carboxylic acid copolymers may be used in combination.

(1-2) The Neutralizing Agent

The neutralizing agent in the present invention may be any basic compound that has the ability to neutralize the carboxyl group in an α-olefin-α,β-unsaturated carboxylic acid copolymer. The neutralizing agent can be exemplified by amine compounds (ammonia and monoamine compounds such as triethylamine and diethylamine and alkanolamine compounds such as 2-amino-2-methyl-1-propanol, N,N-dimethylethanolamine, N,N-diethylethanolamine, 2-dimethylamino-2-methyl-1-propanol, monoisopropanolamine, diisopropanolamine, triisopropanolamine, monoethanolamine, diethanolamine, triethanolamine, N-ethyldiethanolamine, and N-methyldiethanolamine), hydroxides (sodium hydroxide, potassium hydroxide, and so forth), and morpholine. Amine compounds are preferred thereamong based on considerations such as, inter alia, ease of acquisition and the absence of metal ion that remains without evaporating off even upon heating. The alkanolamines are even more preferred among the amino compounds based on their high hydrophilicity and excellent capacity for water-dispersed emulsification. A single one of these neutralizing agents may be used or two or more may be used in combination.

(1-3) The Solvent

Water is the solvent added to the binder resin emulsion of the present invention. The binder resin emulsion of the present invention therefore takes the form of a water-dispersed emulsion. In addition, solvent other than water may also be added on an optional basis in order, inter alia, to adjust the particle size of the obtained water-dispersed emulsion. There is no particular limitation on the solvent other than water, but the highly hydrophilic lower alcohols are preferred, e.g., methanol, ethanol, n-propanol, isopropanol, butanol, and so forth. A single one of these solvents may be used or two or more may be used in combination.

(1-4) Other Substances

Other substances may be added on an optional basis to the binder resin emulsion of the present invention. Examples in this regard are a crosslinking component, in order to supplement the resistance to electrolyte-induced swelling; a rubber component, in order to supplement the electrode's pliability flexibility; a thickener (viscosity adjuster), in order to improve the slurry's coating characteristics on the electrode; a sedimentation inhibitor; an antifoam; and a leveling agent. These other substances may be preliminarily added to the binder resin emulsion of the present invention or may be added during production of the slurry by mixing the active material with the binder resin emulsion. A single one of these other substances may be used or combinations of two or more may be used.

(1-5) Production of the Binder Resin Emulsion

The binder resin emulsion of the present invention contains the aforementioned α-olefin-α,β-unsaturated carboxylic acid copolymer that has been neutralized with neutralizing agent.

There are no particular limitations on the neutralization reaction between the neutralizing agent and α-olefin-α,β-unsaturated carboxylic acid copolymer other than that it is carried out in the presence of water; however, it is generally carried out at ambient pressure. The temperature range at which the reaction can occur at ambient pressure is 0 to 100° C., which is the temperature range in which water maintains the liquid state, and is preferably 40 to 95° C., more preferably 70 to 95° C., and even more preferably 80 to 95° C. It is also particularly preferred that the temperature be raised, either throughout or temporarily, to at least the melting of the copolymer used. Based on considerations, inter alia, of the reaction efficiency and production efficiency, the reaction time is preferably at least 10 minutes and more preferably is 30 minutes to 20 hours and particularly preferably is 1 to 10 hours.

With regard to the amount of the neutralizing agent, there are no particular limitations on this amount as long as it is at least the minimum amount required for the water-dispersed emulsification of the α-olefin-α,β-unsaturated carboxylic acid copolymer. However, viewed from the perspective of avoiding residual excess neutralizing agent, an amount corresponding to the neutralization of 20 to 100 mol % of the carboxyl groups in the copolymer is preferred, while an amount corresponding to the neutralization of 40 to 100 mol % is more preferred and an amount corresponding to the neutralization of 60 to 100 mol % is even more preferred. In specific terms, the use of 0.2 to 1 mol, preferably 0.4 to 1 mol, and more preferably 0.6 to 1 mol 1 N neutralizing agent per 1 mol α,β-unsaturated carboxylic acid present in the α-olefin-α,β-unsaturated carboxylic acid copolymer is suitable.

There are also no particular limitations on the amount of the solvent, e.g., water, again as long as this amount is at least the minimum amount required for the water-dispersed emulsification of the α-olefin-α,β-unsaturated carboxylic acid copolymer. However, since solvent is also added for the purpose of viscosity adjustment during preparation of the slurry by mixing active material with the binder resin emulsion, an excess is preferably not present in the binder resin emulsion. For example, with regard to the water, for example, 30 to 95 mass %, preferably 40 to 90 mass %, and more preferably 50 to 85 mass %, in each case with respect to the total mass of the water and α-olefin-α,β-unsaturated carboxylic acid copolymer, is suitable. In addition, when a solvent other than water is added, the use of the other solvent, for example, at 0.1 to 30 mass %, preferably 0.5 to 20 mass %, and more preferably 1 to 10 mass %, in each case with respect to the solvent as a whole inclusive of water, is suitable.

The amount of neutralizing agent and the amount of water may be suitably adjusted based on the size of the particles in the obtained binder resin emulsion. An average particle size in the binder resin emulsion of, for example, 0.001 to 10 μm, preferably 0.01 to 1 μm, and more preferably 0.05 to 0.3 μm is suitable. As long as the average particle size is at least 0.001 μm, the voids present in the surface of the active material of the energy device electrode will not be filled in and the surface of the active material will also not be coated. An average particle size no greater than 10 μm is preferred because this also avoids the formation of aggregates (lumps) during slurry preparation by mixing active material with the binder resin emulsion and provides excellent handling characteristics for the slurry and excellent coating characteristics for the slurry on the current collector.

(2) Applications of the Binder Resin Emulsion

The binder resin emulsion of the present invention is produced as described above and is generally used as such in the form of the water-dispersed emulsion.

The binder resin emulsion of the present invention is highly suitable for use as a binder for use in energy devices and particularly for use in energy device electrodes. Here, “energy device” denotes electrical storage devices and power generation devices. Examples of energy devices are lithium batteries, capacitors, fuel cells, solar cells, and so forth. Among these, the binder resin emulsion of the present invention is preferred for use in particular for lithium battery electrodes (negative electrode) and capacitor electrodes.

Moreover, the binder resin emulsion of the present invention can be widely applied not only to energy device electrodes, but also to paints and coatings, adhesives, curing agents and hardeners, printing inks, solder resists, polishes, sealants for electronic components, surface-protective films and interlayer dielectric films for semiconductors, electrical insulation varnishes, fibers, various coating resins and molding materials for, for example, biomaterials, and so forth.

(2-1) The Energy Device Electrode

The energy device electrode of the present invention comprises a current collector and a composite layer disposed on at least one side of the current collector. This composite layer is obtained by the steps of

(a) applying onto the current collector a slurry comprising an active material and a binder resin emulsion as described hereinabove for an energy device electrode; and

(b) removing the solvent from the applied slurry.

(2-1-1) The Current Collector

The current collector in the present invention may be an electroconductive substance, and, for example, a metal, etched metal foil, expanded metal, or electroconductive plastic can be used. Aluminum, copper, nickel, and so forth can be used as the metal. Polyaniline, polyacetylene, polypyrrole, polythiophene, poly-p-phenylene, polyphenylenevinylene, and so forth can be used as the electroconductive plastic. The shape of the current collector is not particularly limited, but a thin film configuration is preferred based on a consideration of increasing the lithium battery energy density. The thickness of the current collector is, for example, 5 to 100 μm and is preferably 8 to 70 μm, more preferably 10 to 30 μm, and even more preferably 15 to 25 μm.

(2-1-2) The Composite Layer

The composite layer in the present invention comprises the aforementioned binder resin emulsion containing active material and so forth. The composite layer is obtained, for example, by preparing a slurry by mixing the binder resin emulsion of the present invention, the active material, any optional additional solvent and other additives, and so forth; coating this slurry on the current collector; and drying off the solvent.

(a) The Active Material

The active material in the present invention will vary as a function of the type of energy device being prepared and the polarity of the electrode being prepared, but can be exemplified by graphite, amorphous carbon, coke, active carbon, carbon fiber, silica, alumina, and so forth.

The active material may be used in combination with an electroconductive auxiliary. This electroconductive auxiliary can be exemplified by graphite, carbon black, acetylene black, and so forth. The active material may be used alone or two or more active materials may be used in combination, and the electroconductive auxiliary may be used alone or two or more electroconductive auxiliaries may be used in combination.

(b) The Solvent

There are no particular limitations on the solvent used to form the composite layer, and this may be a solvent capable of the uniform dispersion of the binder resin component such as the copolymer described hereinabove. The solvent used in the hereinabove-described binder resin emulsion may be directly used as the solvent used for formation of the composite layer. For example, water is preferred, and a lower alcohol, such as methanol, ethanol, n-propanol, isopropanol, n-butanol, and so forth, may also be added to the water. A single one of these solvents may be used or two or more may be used in combination.

(c) Other Additives

A thickener can be added to the aforementioned slurry used to produce the composite layer in the present invention in order to improve the slurry's dispersion stability and coating characteristics. There are no particular limitations on the thickener, and the thickener can be exemplified by water-soluble polymers. The water-soluble polymers can be exemplified by plant-derived natural polymers such as guar gum, locust bean gum, quince seed gum, carrageenan, pectin, mannan, starch, agar, gelatin, casein, albumin, collagen, and so forth; microbial-derived natural polymers such as xanthan gum, succinoglycan, curdlan, hyaluronic acid, dextran, and so forth; cellulosic semi-synthetic polymers such as methyl cellulose, ethyl cellulose, hydroxypropyl cellulose, carboxymethyl cellulose, and their derivatives; starch-based semi-synthetic polymers such as carboxymethyl starch and derivatives thereof; alginic acid-type semi-synthetic polymers such as the propylene glycol ester of alginic acid; vinyl-type synthetic polymers such as polyvinyl alcohol, polyvinylpyrrolidone, polyacrylic acid, polyacrylamide, and derivatives thereof; alkylene oxide-type synthetic polymers such as polyethylene oxide and so forth; and inorganic polymers such as clay minerals and silica. The cellulosic semi-synthetic polymers are preferred among the preceding based on considerations such as ease of acquisition and thickening effect. Carboxymethyl cellulose and its derivatives are more preferred thereamong because they combine the preceding with a binding function. A single one of these thickeners may be used or two or more may be used in combination.

(d) Composition of the Components Forming the Composite Layer

The active material constituent of the composite layer is added at, for example, 50 to 99 mass % and preferably 80 to 99 mass %, in each case with reference to the composite layer obtained upon solvent elimination.

The binder resin emulsion is suitably added such that the solids fraction in the binder resin emulsion is present at, for example, 1 to 10 mass % and preferably 2 to 7 mass % with respect to the composite layer obtained upon solvent elimination.

The solvent is preferably present such that the solids fraction in the binder resin solution after solvent addition is, for example, 1 to 70 mass % and preferably 10 to 60 mass %, although this will depend on the amount of solvent in the binder resin solution.

The other substances are preferably added at, for example, 0.1 to 20 mass % and preferably 1 to 10 mass % with respect to the composite layer obtained upon solvent elimination.

(2-1-3) The Method of Electrode Production

The method of producing the energy device electrode of the present invention comprising a current collector and a composite layer disposed on at least one side of the current collector, comprises the steps of

(i) coating at least one side of the current collector with a slurry comprising the active material and the above-described binder resin emulsion for energy device electrodes;

(ii) removing the solvent from the applied slurry; and

(iii) optionally rolling the obtained current collector/composite layer laminate.

Step (i) is carried out by preparing a slurry comprising the active material and the above-described binder resin emulsion for energy device electrodes and coating this slurry on at least one side and preferably on both sides of the current collector. Coating can be carried out using, for example, a transfer roll or comma coater. Coating is suitably carried out in such a manner that the active material utilization ratio per unit area for the opposing electrodes is negative electrode/positive electrode=at least 1. The slurry is coated in an amount that provides a dry mass for the composite layer of, for example, 1 to 50 mg/cm², preferably 5 to 30 mg/cm², and more preferably 10 to 15 mg/cm².

Step (ii) is carried out by removing the solvent by drying, for example, for 1 to 20 minutes and preferably 3 to 10 minutes at 50 to 150° C. and preferably 80 to 120° C.

Step (iii) is carried out using, for example, a roll press, wherein pressing is carried out so as to bring the bulk density of the composite layer to 1 to 5 g/cm³ and preferably 2 to 4 g/cm³. In order, inter alia, to remove residual solvent and adsorbed water present in the electrode, for example, vacuum drying may additionally be carried out for 1 to 20 hours at 100 to 150° C.

(2-2) The Battery

The energy device electrode of the present invention can be additionally combined with an electrolyte solution to produce a desired energy device.

(2-2-1) The Electrolyte Solution

The electrolyte solution used in the present invention will vary as a function of the type of energy device and is not particularly limited as long as it can bring about the appearance of the function of the energy device under consideration.

With regard to the electrolyte in the electrolyte solution, for example, a lithium compound such as LiPF₆ can be used for a lithium battery while an ammonium compound such as tetraethylammonium tetrafluoroborate can be used for capacitors. The electrolyte solution is made by the suitable addition and dissolution of such an electrolyte in a solvent other than water, for example, an organic solvent such as a carbonate such as propylene carbonate, ethylene carbonate, butylene carbonate, dimethyl carbonate, diethyl carbonate, and methyl ethyl carbonate; a lactone such as γ-butyrolactone; an ether such as trimethoxymethane, 1,2-dimethoxyethane, diethyl ether, 2-ethoxyethane, tetrahydrofuran, and 2-methyltetrahydrofuran; a sulfoxide such as dimethyl sulfoxide; an oxolane such as 1,3-dioxolane and 4-methyl-1,3-dioxolane; a nitrogenous solvent such as acetonitrile, nitromethane, and N-methyl-2-pyrrolidone; an ester such as methyl formate, methyl acetate, butyl acetate, methyl propionate, ethyl propionate, and the triesters of phosphoric acid; a glyme such as diglyme, triglyme, and tetraglyme; a ketone such as acetone, diethyl ketone, methyl ethyl ketone, and methyl isobutyl ketone; a sulfone such as sulfolane; an oxazolidinone such as 3-methyl-2-oxazolidinone; and a sultone such as 1,3-propanesultone, 4-butanesultone, and naphthasultone.

(2-2-2) The Method of Energy Device Production

There are no particular limitations on energy devices of the present invention, and these energy devices can be produced using known methods, with the exception that an energy device electrode of the present invention as described above is employed.

(3) Specific Methods for Producing Energy Device Electrodes and Energy Devices

Specific examples are described below for the production of energy device electrodes of the present invention and the production of energy devices of the present invention, taking up the example of lithium battery electrodes and a lithium battery that uses these lithium battery electrodes and a capacitor electrode and a capacitor that uses this capacitor electrode.

(3-1) The Lithium Battery Electrodes

(3-1-1) The Current Collector

The lithium battery current collector used by the present invention can be an electroconductive substance, and, for example, a metal can be used. Specific examples of usable metals are aluminum, copper, and nickel. Moreover, the shape of the current collector is not particularly limited, but a thin film configuration is preferred from the standpoint of achieving a high energy density for the lithium battery. The thickness of the current collector is, for example, 5 to 30 μm, and is preferably 8 to 25 μm.

(3-1-2) The Active Material

The lithium battery active material used by the present invention, for example, can be an active material that can reversibly incorporate and release lithium ions due to the charging and discharging of the lithium battery, but is not otherwise particularly limited. However, the positive electrode functions to release lithium ions during charging and incorporate lithium ions during discharge, while the negative electrode functions in reverse to the positive electrode by incorporating lithium ions during charging and releasing lithium ions during discharge, and as a consequence different materials adapted to each of these functionalities are ordinarily used for the active material of the positive electrode and the active material of the negative electrode.

The negative electrode active material is, for example, preferably a carbon material such as graphite, amorphous carbon, carbon fiber, coke, or active carbon, but composites of these carbon materials with a metal, e.g., silicon, tin, silver, and so forth, or an oxide thereof can also be used.

On the other hand, the positive electrode active material is, for example, preferably a lithium-containing complex metal oxide containing at least lithium and at least one metal selected from iron, cobalt, nickel, and manganese. A single one of these active materials may be used or two or more may be used in combination. The aforementioned electroconductive auxiliary is preferably used in combination with the positive electrode active material.

(3-1-3) Otherwise, the Composite Layer, Solvent, and Other Additives are as Described in the Preceding Section “(2-1) The Energy Device Electrode”.

(3-2) The Method of Lithium Battery Electrode Production

In principle, the method of producing a lithium battery electrode of the present invention is as described in the preceding section “(2-1-3) The method of electrode production”.

However, in those instances where the composite layer is subjected to rolling, pressing is suitably carried out such that the bulk density of the composite layer in the case of a negative electrode composite layer is, for example, 1 to 2 g/cm² and preferably 1.2 to 1.8 g/cm³ and in the case of a positive electrode composite layer is, for example, 2 to 5 g/cm³ and preferably 3 to 4 g/cm³. In order, inter alia, to remove residual solvent and adsorbed water present in the electrode, for example, vacuum drying may additionally be carried out for 1 to 20 hours at 100 to 150° C.

(3-3) The Lithium Battery

The lithium battery electrode of the present invention can be additionally combined with an electrolyte solution to produce a lithium battery.

(3-3-1) The Electrolyte Solution

The electrolyte solution used by the lithium battery of the present invention is not particularly limited as long as it can bring about the appearance of functionality as a lithium battery. The electrolyte solution can be, for example, a solution obtained by dissolving an electrolyte, e.g., LiClO₄, LiBF₄, LiI, LiPF₆, LiCF₃SO₃, LiCF₃CO₂, LiAsF₆, LiSbF₆, LiAlCl₄, LiCl, LiBr, LiB(C₂H₅)₄, LiCH₃SO₃, LiC₄F₉SO₃, Li(CF₃SO₂)₂N, and Li[(CO₂)₂]₂B, in an organic solvent as described above for application with electrolytes. Preferred thereamong is a solution of LiPF₆ dissolved in a carbonate. The electrolyte solution used in the lithium battery may be prepared, for example, using a single one of the aforementioned organic solvents or a combination of two or more and using a single one of the aforementioned electrolytes or a combination of two or more.

(3-2-2) The Method for Producing the Lithium Battery

There are no particular limitations on the method of producing the lithium battery of the present invention and any known method can be employed. For example, the two electrodes, i.e., the positive electrode and negative electrode, may first be wound into a coil with a separator interposed therebetween wherein the separator comprises a microporous polyethylene film. The resulting spiral-wound assembly may then be inserted into a battery can and a tab terminal, which has previously been welded to the current collector for the negative electrode, may then be welded to the bottom of the battery can. The electrolyte solution may be introduced into the obtained battery can; a tab terminal, which has previously been welded to the current collector for the positive electrode, may then be welded to the lid of the battery; the lid may be placed on the top of the battery can with an insulating gasket disposed therebetween; and the lithium battery may be obtained by sealing by crimping the region where the lid and battery can are in contact.

(3-4) The Capacitor Electrode

(3-4-1) The Current Collector

The capacitor current collector used by the present invention can be an electroconductive substance, and, for example, metal foil, etched metal foil, or an expanded metal can be used. The material can be specifically exemplified by aluminum, tantalum, stainless steel, copper, titanium, and nickel, with aluminum being preferred thereamong. The thickness of the current collector is not particularly limited and, for example, is generally 5 to 100 μm, preferably 10 to 70 μm, and more preferably 15 to 30 μm. A thickness of at least 5 μm is preferred for the corresponding ease of handling, while a thickness no larger than 100 μm is preferred because this avoids having the current collector take up an excessively large volume in the electrode and thereby enables the maintenance of a satisfactory capacity by the capacitor.

(3-4-2) The Active Material

The capacitor active material used in the present invention is not particularly limited as long as it has the ability to form an electric double layer at the interface with the electrolyte due to capacitor charge/discharge. Active carbon, active carbon fiber, silica, and alumina are examples. Preferred thereamong is active carbon based on, inter alia, its large specific surface area. Active carbon with a surface area of preferably 500 to 5000 m²/g and more preferably 1500 to 3000 m²/g is suitable. A single one of these active materials may be used or two or more may be used in combination.

(3-4-3) Otherwise, the Composite Layer, Solvent, and Other Additives are as Described in the Preceding Section “(2-1) The Energy Device Electrode”.

(3-5) The Method of Producing the Capacitor Electrode

The method of producing the capacitor electrode of the present invention is in principle as described in the preceding section “(2-1-3) The method of electrode production”.

(3-6) The Capacitor

The capacitor electrode of the present invention can be additionally combined with an electrolyte solution to produce a capacitor.

(3-6-1) The Electrolyte Solution

There are no particular limitations on the electrolyte solution used by the capacitor of the present invention as long as it can bring about the appearance of capacitor functionality. The electrolyte solution can be, for example, a solution obtained by dissolving an electrolyte, e.g., tetraethylammonium tetrafluoroborate, triethylmethylammonium tetrafluoroborate, or tetraethylammonium hexafluorophosphate, in an organic solvent as described above for application with electrolytes. Preferred thereamong is a solution of tetraethylammonium tetrafluoroborate dissolved in a carbonate and particularly propylene carbonate. The electrolyte solution used in the capacitor may be prepared, for example, using a single one of the aforementioned organic solvents or a combination of two or more and using a single one of the aforementioned electrolytes or a combination of two or more.

(3-6-2) The Method of Producing the Capacitor

There are no particular limitations on the method of producing the capacitor of the present invention and any known method can be utilized. For example, take-out electrodes (lead wires) are first connected to the two electrodes and these are then rolled into a coil with a separator interposed therebetween. The obtained spiral-wound assembly is inserted into a case; electrolyte solution is introduced; and the capacitor is then obtained by housing a rubber packing in such a manner that a portion of the lead wires is exposed on the outside.

### EXAMPLES

The present invention is more particularly described by the examples provided herebelow, but the present invention is not limited to these examples.

<Preparation of the Binder Resin Emulsion>

### Example 1

A 2-liter separable flask equipped with a stirrer, thermometer, and reflux condenser was set up. To this separable flask were added 150 g of an ethylene-methacrylic acid copolymer (MFR: 60 g/10 min, ethylene unit/methacrylic acid unit=80/20 (mass ratio), melting point: 87° C.) as the α-olefin-α,β-unsaturated carboxylic acid copolymer, 826.7 g purified water, and 23.3 g N,N-dimethylethanolamine (this amount corresponded to the neutralization of 75 mol % of the carboxyl groups in the aforementioned copolymer) as the neutralizing agent. The temperature was raised to 95° C. while stirring the contents of the flask followed by holding for 1 hour at this same temperature to bring about the water-dispersed emulsification of the copolymer by the neutralization reaction. The temperature was then dropped to 88° C. and this temperature was held for 3 hours in order to bring the neutralization reaction to completion; cooling to room temperature subsequently yielded a binder resin emulsion of the present invention. The average particle size in the obtained emulsion was approximately 0.13 μm, and the nonvolatile fraction after drying under ambient pressure for 2 hours at 150° C. was 15.2 mass %.

### Comparative Example 1

A 40 mass % water-dispersed emulsion of styrene-butadiene copolymer (SBR) from ZEON Corporation was prepared.

<Evaluation of the Binder Resin Emulsion>

Various properties (adsorptivity to carbon material, sedimentation behavior of the carbon material, electrolyte solution permeability of the composite layer obtained from the binder resin emulsion) of the binder resin emulsion were evaluated as described below.

Test (1) Adsorptivity to Carbon Material

Carbon material (trade name: MAG, from Hitachi Chemical Co., Ltd., massive artificial graphite for application as the active material of lithium battery negative electrodes, average particle size=20 μm) and a water-soluble polymeric thickener (sodium salt of carboxymethyl cellulose (CMC), 2 mass % aqueous solution) were blended with each other at 96.25 mass parts as solids for the former and 1.25 weight parts as solids for the latter and were subjected to a preliminary mixing process. This 97.5 mass parts of the preliminary mixture was then mixed with 2.5 mass parts as solids of the binder resin emulsion of Example 1 to provide a total of 100 mass parts. Purified water was added so as to bring the total solids fraction to 45.5 mass % and the main mixing process was then carried out to obtain a slurry.

This slurry was subsequently introduced into a container and the container was sealed and held at quiescence for 96 hours at room temperature, followed by dilution to twice the quantity (twice the mass) with purified water. This was subjected to centrifugal separation for 20 minutes at 10,000 rpm to induce sedimentation of the carbon material into a lower layer. The liquid of the upper layer was dried under ambient pressure for 2 hours at 15° C. and the resulting nonvolatile fraction was used to determine the unadsorbed quantity, that is, the amount that did not adsorb to the carbon material in the slurry. The adsorptivity to the carbon material in the slurry was evaluated based on the amount of adsorption calculated using the following equation.
amount of adsorption (mass %)=[(total amount of binder resin in the slurry−unadsorbed amount)/total amount of binder resin in the slurry]×100

The quantity of adsorption is suitably no more than 10 mass %.

Test (2) The Sedimentation Behavior of the Carbon Material

A slurry prepared as in Test (1) above was introduced into a container and the container was sealed and held at quiescence for 96 hours at room temperature. The slurry at the bottom of the container was then mixed with a spatula and the sedimentation behavior of the carbon material in the slurry was examined manually.

Test (3) Electrolyte Solution Permeability into the Composite Layer

A composite layer with a thickness of approximately 200 μm was formed by uniformly coating a slurry prepared as in Test (1) above on a glass plate using a microapplicator; drying at ambient pressure for 1 hour at 80° C.; and then carrying out a vacuum heat treatment for 5 hours at 120° C. 1 μL electrolyte solution (equivolume mixed solution of ethylene carbonate, dimethyl carbonate, and diethyl carbonate containing LiPF₆ dissolved at a 1 M concentration) was deposited at room temperature on the surface of this composite layer and the course of electrolyte solution permeation into the interior of the composite layer was monitored with elapsed time using a CCD camera. The electrolyte solution permeability into the composite layer was evaluated in terms of the time elapsed (msec) after deposition of the electrolyte solution until the residual amount of electrolyte solution on the surface of the composite layer reached 20 volume %. An elapsed time of no more than 500 msec is suitable.

In the control experiment, the aforementioned Tests (1) to (3) were repeated using the emulsion of Comparative Example 1 in place of the binder resin emulsion of Example 1.

The results of the tests are shown in Table 1.

TABLE 1

| | | Comparative |
|---|---|---|
| | Example 1 | Example 1 |
| adsorptivity to carbon | 4 | 56 |
| material in the slurry | | |
| (mass %) | | |
| sedimentation behavior | no sedimentation | sedimentation |
| of the carbon material | | occurred |
| in the slurry | | |
| electrolyte solution | 300 | 1200 |
| permeability into the | | |
| composite layer (msec) | | |

Table 1 demonstrates that, in comparison to the styrene-butadiene copolymer (SBR), which is a heretofore known material, the binder resin emulsion of the present invention prepared in Example 1 evidences a low adsorptivity to the carbon material in the slurry and thereby provides an excellent dispersion stability (resistance to sedimentation) for the carbon material in the slurry and, because it resists coating the surface of the carbon material, also enables facile permeation by the electrolyte solution into the composite layer.

<Fabrication of a Lithium Battery Electrode>

### Example 2

Slurry prepared as in Test (1) above was uniformly coated with a microapplicator on one surface of a negative electrode current collector (Hitachi Cable, Ltd., rolled copper foil, thickness=14 μm, 200×100 mm) so as to give a dry mass for the composite layer of approximately 12.5 mg/cm². A composite layer was then formed by drying for 1 hour under ambient pressure at 80° C. This was followed by compression forming with a roll press such that the bulk density of the composite layer was brought to 1.5 g/cm³ or 1.8 g/cm³ and then punching with a punch into a diameter of 9 mm. This was subjected to a vacuum heat treatment for 5 hours at 120° C., yielding a negative electrode that had disposed on its surface a composite layer obtained from the active material and a binder resin emulsion of the present invention.

### Comparative Example 2

A negative electrode was fabricated as in Example 2, but in this case using a slurry produced by repeating Test (1) using the emulsion of Comparative Example 1.

### Example 3

Slurry prepared as in Test (1) above was uniformly coated with a transfer roll on both surfaces of a negative electrode current collector (Hitachi Cable, Ltd., rolled copper foil, thickness=10 μm, 200×100 mm) so as to give a dry mass for the composite layer of 29 mg/cm². A composite layer was then formed by drying the coated material for 5 minutes in a conveyor oven at 120° C. followed by compression forming with a roll press to bring the bulk density of the composite layer to 1.8 g/cm³. This was cut to 56 mm square to produce a strip-shaped sheet and subjected to a vacuum heat treatment for 5 hours in a vacuum drier at 120° C. to yield a negative electrode.

### Comparative Example 3

A negative electrode was fabricated as in Example 3, but in this case using a slurry prepared by repeating Test (1) using the emulsion of Comparative Example 1.

<Lithium Battery Fabrication>

### Example 4

The negative electrode of Example 2 was set up as a working electrode. 1 mm-thick lithium metal with a lightly polished surface (Mitsui Kinzoku Kogyo Co., Ltd.) was set up as the counter electrode. A separator (Tonen Tapyrus Co., Ltd., microporous polyolefin, thickness 25 μm, this also applies below) wetted with electrolyte solution was prepared as an insulator for separating the working electrode and counter electrode. Working in an argon gas filled glove box, a laminate was fabricated by the stacking the aforementioned working electrode and counter electrode in the sequence separator-counter electrode-separator-working electrode-separator. This was inserted in a stainless steel coin cell outer container and covered with a stainless steel lid followed by sealing with a crimper for coin cell fabrication to yield a CR2016 coin cell.

### Comparative Example 4

A CR2016 coin cell was fabricated as in Example 4, but in this case using the negative electrode of Comparative Example 2 as the working electrode.

### Example 5

The following were blended so as to provide a mass ratio of 86.0:3.2:9.0:1.8 as solids: lithium cobaltate (average particle size 10 μm) as positive electrode active material, polyvinylidene fluoride (PVDF, 12 mass % N-methyl-2-pyrrolidone (NMP) solution) as binder resin, a synthetic graphite-type electroconductive auxiliary (trade name: JSP, product of Nippon Graphite Industries, ltd., average particle size=3 μm), and a carbon black-type electroconductive auxiliary (trade name: Denka Black HS-100, product of Denki Kagaku Kogyo Kabushiki Kaisha, average particle size 48 nm). To this blend was added sufficient NMP to bring the total solids fraction to 60.0 mass %, followed by mixing to yield a slurry. The obtained slurry was uniformly coated using a transfer roll on both surfaces of a positive electrode current collector (aluminum foil, thickness=10 μm) so as to provide a dry mass for the composite layer of 65 mg/cm². The coated material was then formed into a composite layer by drying for 5 minutes in a conveyor oven at 120° C. followed by compression forming with a roll press so as to bring the bulk density of the composite layer to 3.2 g/cm³. This was cut to a width of 54 mm to produce a strip-shaped sheet followed by a vacuum heat treatment for 5 hours in a 120° C. vacuum drier to yield a positive electrode. The negative electrode of Example 3 was used as the negative electrode.

A nickel current collector tab was ultrasonically bonded to an exposed region on the current collector for the prepared negative electrode and for the prepared positive electrode, which were then wound up by an automatic winder with a separator interposed therebetween to yield a spiral-wound assembly. This spiral-wound assembly was inserted into a battery can; the current collector tab terminal for the negative electrode was welded to the bottom of the battery can; and the current collector tab terminal for the positive electrode was thereafter welded to the lid. This was then subjected to drying at reduced pressure for 12 hours at 60° C. with the lid open. Then, while operating in an argon gas filled glove box, approximately 5 mL electrolyte solution (equivolume mixed solution of ethylene carbonate, dimethyl carbonate, and diethyl carbonate containing LiPF₆ dissolved at a 1 M concentration) was injected into the battery can. Sealing was thereafter carried out by crimping the battery can with the lid to produce an 18650-type lithium battery (cylindrical, diameter=18 mm, height=65 mm).

### Comparative Example 5

An 18650-type lithium battery was fabricated as in Example 5, but in this case using the negative electrode of Comparative Example 3 as the negative electrode.

<Lithium Battery Evaluation>

Several characteristics (first charge-discharge characteristics and charge-discharge cycling characteristics) of the lithium batteries were evaluated as described herebelow.

Test (4) First Charge-Discharge Characteristics of the Lithium Batteries

The first charge-discharge characteristics, which are evaluated on the basis of the discharge capacity, the irreversible capacity, and the charge-discharge efficiency during the first charge-discharge, are an indicator of the charge-discharge characteristics of a lithium battery. The discharge capacity during the first charge-discharge is an indicator of the capacity of the fabricated battery, and a larger discharge capacity during the first charge-discharge is presumed to indicate a battery with a larger capacity.

The irreversible capacity during the first charge-discharge is calculated from first charging capacity—first discharge capacity, and a smaller irreversible capacity during the first charge-discharge is generally taken as indicative of an excellent battery that will resist a reduction in capacity even during repetition of the charge-discharge cycle.

The charge-discharge efficiency (%) during the first charge-discharge is calculated from [(first discharge capacity/first charging capacity)×100], and a larger charge-discharge efficiency during the first charge-discharge is taken as indicative of an excellent battery that will resist a reduction in capacity even during repetition of the charge-discharge cycle.

The CR2016 coin cell of Example 4 was used to evaluate the first charge-discharge characteristics of an energy device obtained from the binder resin emulsion of the present invention.

While operating in a glove box under an argon atmosphere, the coin cell from Example 4 was subjected to constant-current charging at 23° C. to 0 V at a charging current of 0.2 mA using a charge-discharge instrument (TOSCAT3100 from Toyo System Co. Ltd). Since the counterelectrode is lithium metal, the working electrode becomes a positive electrode in relation to the potential, and this constant-current charging is thus a discharge in precise terms. In the present case, however, “charging” is defined as the insertion reaction of lithium ions into the graphite of the working electrode. The process was switched to constant-voltage charging at the point at which the voltage reached 0 V and charging was continued until the current value declined to 0.02 mA, after which constant-current discharge was carried out at a discharge current of 0.2 mA to a discharge end voltage of 1.5 V. The first charge-discharge characteristics of the coin cell of Example 4 were evaluated by measuring the charging capacity per 1 g of the carbon material and the discharge capacity per 1 g of the carbon material during this process and calculating the irreversible capacity and the charge-discharge efficiency.

The same test and evaluation was also carried out on the coin cell of Comparative Example 4.

The first charge-discharge characteristics of the coin cell were judged to be excellent when the discharge capacity in the case of the composite layer with a bulk density of 1.8 g/cm³ was at least 340 mAh/g. The results are shown in Table 2.

TABLE 2

| | | | | Comparative |
|---|---|---|---|---|
| item | | | Example 4 | Example 4 |
| first | composite | discharge | 362.5 | 360.7 |
| charge- | layer | capacity (mAh/g) | | |
| discharge | bulk | irreversible | 26.8 | 28.1 |
| characteristics | density: | capacity (mAh/g) | | |
| | 1.5 g/cm³ | charge-discharge | 93.1 | 92.8 |
| | | efficiency (%) | | |
| | composite | discharge | 352.3 | 337.8 |
| | layer | capacity (mAh/g) | | |
| | bulk | irreversible | 31.6 | 32.0 |
| | density: | capacity (mAh/g) | | |
| | 1.8 g/cm³ | charge-discharge | 91.8 | 91.4 |
| | | efficiency (%) | | |

Table 2 shows that, even for the coin cell of Example 4, which employed a high-density negative electrode (composite layer bulk density=1.8 g/cm³) that had been strongly compression formed with a roll press, permeation by the electrolyte solution into the composite layer was very much unimpaired and excellent first charge-discharge characteristics were seen.

Test (5) Charge-Discharge Cycle Performance of the Lithium Batteries

Using a charge-discharge instrument (TOSCAT3000 from Toyo System Co., Ltd.), the 18650-type lithium battery obtained in Example 5 was subjected to constant-current charging to 4.2 V at 23° C. and a charging current of 800 mA; the process was switched to constant-voltage charging when the voltage reached 4.2 V; and charging was continued until the current value declined to 20 mA. The first discharge capacity was then measured by carrying out constant-current discharge at a discharge current of 800 mA to a discharge end voltage of 3.0 V. 200 charge-discharge cycles were then repeated with charging and discharging under these same conditions constituting 1 cycle. The charge-discharge cycle performance of the 18650-type lithium battery was evaluated based on the discharge capacity retention rate after the 200 cycles using the first discharge capacity as the 100% retention rate. The discharge capacity retention rate was calculated using the following formula.
discharge capacity retention rate (%) discharge capacity after 200 cycles/first discharge capacity×100

The same test and evaluation was also carried out on the lithium battery of Comparative Example 5.

When the discharge capacity retention rate is at least 85% and preferably at least 90%, the charge-discharge cycle performance can be judged to be excellent since the battery resists the occurrence of capacity fading even during repetitive charge-discharge cycling.

The results are shown in Table 3.

TABLE 3

| | Example 5 | Comparative Example 5 |
|---|---|---|
| discharge capacity | 90 | 80 |
| retention rate (%) | | |

As shown in Table 3, the lithium battery (Example 5) that used a negative electrode (Example 4) fabricated using a binder resin emulsion of the present invention was found to have a charge-discharge cycle performance superior to that of the lithium battery of Comparative Example 5.

<Capacitor Electrode Fabrication>

### Example 6

Electrode active material (active carbon, average particle size=2 μm, specific surface area=2000 m²/g), electroconductive auxiliary (acetylene black), and water-soluble polymeric thickener (CMC, ammonium salt of carboxymethyl cellulose, 2 mass % aqueous solution) were blended so as to provide 100 mass parts, 10 mass parts, and 6 mass parts as solids, respectively, followed by a preliminary mixing process. To this preliminary mixture was added 6 mass parts as solids of the binder resin emulsion of the present invention prepared in Example 1. Pure water was added to the obtained emulsion so as to bring the total solids fraction to 20 mass % and a slurry was produced by the main mixing process. This slurry was uniformly coated on both surfaces of a current collector (aluminum foil with a surface roughened by chemical etching, thickness=20 μm, 40×10 mm). The coated material was then dried for 60 minutes at 100° C. to form an 80 μm composite layer on one side, thereby yielding the electrode.

### Comparative Example 6

An electrode was obtained operating entirely as in Example 6, except that in this case a 60 mass % water-dispersed emulsion of polytetrafluoroethylene (PTFE) from Daikin Industries, Ltd., was used in place of the binder resin emulsion of Example 6.

<Capacitor Fabrication>

### Example 7

Two of the electrodes obtained in Example 6 were used; an aluminum lead wire was ultrasonically bonded to each on an exposed region of the current collector; and these were wound up by an automatic winder with a separator interposed therebetween to fabricate a spiral-wound assembly. This spiral-wound assembly was inserted into an aluminum case, followed by drying under reduced pressure for 12 hours at 60° C. with the lid open. Then, while operating in a glove box under an argon atmosphere, electrolyte solution (propylene carbonate solution containing tetraethylammonium tetrafluoroborate dissolved at a concentration of 1 M) was introduced, followed by housing a rubber packing that exposed a portion of the lead wires to the outside, thereby yielding the capacitor.

### Comparative Example 7

A capacitor was fabricated as in Example 7, but using the electrode of Comparative Example 6 rather than the electrode of Example 6.

<Evaluation of the Characteristics of the Capacitors>

The capacity, direct current resistance, and long-term reliability were evaluated on the capacitors of Example 7 and Comparative Example 7.

For the capacity, the time to reach 1.0 V at a discharge current of 100 mA was measured. Long times are indicative of a high capacity and an excellent capacitor. In general, times longer than 13 seconds can be taken as indicative of an excellent capacitor.

The direct current resistance was measured using an impedance analyzer from Solartron. A direct current resistance of no more than 0.5Ω can be taken as indicative of an excellent capacitor.

The long-term reliability was evaluated based on the capacity reduction when the capacitor was placed under a load of 1.8 V and held at 70° C. for 10,000 hours. The capacity reduction is calculated from the following formula.
capacity reduction (%) (initial capacity capacity after 10,000 hours)/initial capacity×100
A lower capacity reduction can be taken as indicative of a higher long-term reliability. A capacity reduction of no more than 25% is preferred from the perspective of long-term reliability.

The results are shown in Table 4.

TABLE 4

| electrode | Example 7 | Comparative Example 7 |
|---|---|---|
| capacity (sec) | 14 | 12 |
| direct current | 0.2 | 1.0 |
| resistance (Ω) | | |
| long-term | 15 | 35 |
| reliability (%) | | |

As is shown in Table 4, the capacitor (Example 7) that used electrodes (Example 6) fabricated using a binder resin emulsion of the present invention has a lower direct current resistance and a better long-term reliability than the capacitor of Comparative Example 7.

1. A binder resin emulsion for an energy device electrode, comprising: a copolymer of an α,β-unsaturated carboxylic acid and an α-olefin that has been neutralized with a neutralizing agent; and water.

2. The binder resin emulsion for an energy device electrode according to claim 1, wherein the copolymer is an ethylene-(meth)acrylic acid copolymer, and the neutralizing agent is an amine compound.

3. The binder resin emulsion for an energy device electrode according to claim 2, wherein the copolymer has an MFR of 30 to 100 g/10 min, and the ethylene unit/(meth)acrylic acid unit mass ratio is 85/15 to 75/25.

4. The binder resin emulsion for an energy device electrode according to claim 2, wherein the neutralizing agent is an alkanolamine.

5. The binder resin emulsion for an energy device electrode according to claim 1, wherein 20 to 100 mol % of the carboxyl groups in the copolymer are neutralized.

6. The binder resin emulsion for an energy device electrode according to claim 1, wherein said α-olefin is a compound with the following formula (I):
CH₂═CH—R (I)
wherein R is selected from the hydrogen atom, C₁₋₁₂ alkyl groups which may be branched or unbranched and saturated or unsaturated, C₃₋₁₀ alicyclic alkyl groups which may be saturated or unsaturated, and C₆₋₁₂ aryl groups.

7. The binder resin emulsion for an energy device electrode according to claim 1, wherein said α-olefin is selected from the group consisting of ethylene, propylene and butylene.

8. The binder resin emulsion for an energy device electrode according to claim 1, wherein said α-olefin is ethylene.

9. The binder resin emulsion for an energy device electrode according to claim 1, wherein said α,β-unsaturated carboxylic acid is a compound with the following formula (II): 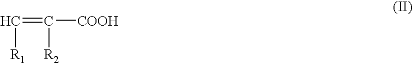
wherein R₁ and R₂ may be the same as each other or may differ from one another and are selected from the hydrogen atom, carboxyl group, acetyl group, C₁₋₁₂ alkyl groups which may be branched or unbranched and saturated or unsaturated, C₃₋₁₀ alicyclic alkyl groups which may be saturated or unsaturated, and C₆₋₁₂ aryl groups.

10. The binder resin emulsion for an energy device electrode according to claim 1, wherein said α,β-unsaturated carboxylic acid is selected from the group consisting of (Meth)acrylic acid, ethacrylic acid, crotonic acid, maleic acid, itaconic acid, citraconic acid and fumaric acid.

11. The binder resin emulsion for an energy device electrode according to claim 1, wherein said α,β-unsaturated carboxylic acid is (Meth)acrylic acid.

12. The binder resin emulsion for an energy device electrode according to claim 1, wherein said neutralizing agent is an amine compound.

13. The binder resin emulsion for an energy device electrode according to claim 1, wherein said copolymer is an ethylene-(meth)acrylic acid copolymer.

14. An energy device electrode having a current collector and a composite layer disposed on at least one side of the current collector, wherein said composite layer is obtained by the steps of:
(a) applying onto the current collector a slurry comprising an active material and the binder resin emulsion for an energy device electrode according to claim 1; and
(b) removing a solvent from the applied slurry.

15. The energy device electrode according to claim 14, wherein said current collector is copper.

16. The energy device electrode according to claim 14, wherein said active material is a carbon.

17. An energy device electrode having a current collector and a composite layer disposed on at least one side of the current collector, wherein said composite layer is obtained by the steps of:
(a) applying onto the current collector a slurry comprising an active material and the binder resin emulsion for an energy device electrode according to claim 2; and
(b) removing a solvent from the applied slurry.

18. The energy device electrode according to claim 14, wherein said solvent is water.

19. An energy device comprising the energy device electrode according to claim 14.

20. The energy device according to claim 15, wherein the energy device is a lithium battery or a capacitor.
